(19) United States
(12) Patent Application Publication
(10) Pub. No.: US 2007/0202928 A1
(43) Pub. Date: Aug. 30, 2007

(54) Method and apparatus for user equipment (UE) channel acquisition in the presence of large frequency uncertainty in WCDMA signals

(76) Inventors: Uri M. Landau, San Diego, CA (US); Francis Swarts, San Diego, CA (US); Mark Kent, Vista, CA (US)

Correspondence Address: MCANDREWS HELD & MALLOY, LTD, 500 WEST MADISON STREET, SUITE 3400, CHICAGO, IL, 60661, US

(21) Appl. No.: 11/364,752

(22) Filed: Feb. 28, 2006

(51) Int. Cl. H04B 1/38

(52) U.S. Cl. 455/567

(57) ABSTRACT

Aspects of a method and apparatus for user equipment (UE) channel acquisition in the presence of large frequency uncertainty in wideband code division multiple access (WCDMA) signals are provided. An efficient time-frequency domain search that may be utilized in cell communications may be performed by devising criteria that eliminates the unlikely frequencies hypotheses. An estimate for the frequency offset may be estimated in the remaining subset. For WCDMA applications, a UE may comprise a baseband processor that is enabled to detect a primary synchronization channel (P-SCH) code (PSC) for initial network synchronization. A portion of the baseband processor may generate a plurality of signal peak-to-noise-floor-average ratios associated with a plurality of test frequencies produced by a crystal oscillator. A highest of the signal peak-to-noise-floor-average ratios may be selected to determine the frequency offset of the crystal oscillator for use in power up operations

### CROSS-REFERENCE TO RELATED APPLICATIONS/INCORPORATION BY REFERENCE

This application makes reference to U.S. application Ser. No. ______ (Attorney Docket No. 16893US01) filed on even date herewith.

The above stated application is hereby incorporated by reference in its entirety.

### FIELD OF THE INVENTION

Certain embodiments of the invention relate to the processing of wireless data. More specifically, certain embodiments of the invention relate to a method and apparatus for a user equipment (UE) channel acquisition in the presence of large frequency uncertainty in wideband code division multiple access (WCDMA) signals.

### BACKGROUND OF THE INVENTION

The increased performance and communication capacity of third-generation (3G) wireless systems has generated a growing number of mobile user equipment (UE) for voice, data and multimedia traffic. For example, wideband code division multiple access (WCDMA) is a radio communication specification that enables increased performance by carrying user traffic using complex modulated radio frequency (RF) signals and by performing a number of vital protocol functions for mobile UE and base station operation.

One such function may be initial time-frequency synchronization when establishing connections between the mobile UE and the base station. In order for a mobile UE to communicate with a base station, for example, the mobile UE may search for an available cell and may request a connection. During the cell search, the mobile UE searches for a cell and corresponding base stations, and determines the downlink scrambling code and common channel frame synchronization of that cell. The mobile UE determines the timing of, what is generally known as the cell slot of the primary synchronization channel (P-SCH) code (PSC) of the physical synchronization channel (SCH) to synchronize with the targeted cell. The mobile UE commonly uses a single matched filter to find the P-SCH code by detecting the peak of the filter response in the received signal. To complete the synchronization, in WCDMA, the UE may perform what is generally known as frame synchronization and identification of the code group of the scrambling code. The mobile UE detects the secondary synchronization channel (S-SCH) code (SSC) of the PSC in the received signal and correlates it with all possible secondary synchronization code sequences. The frame synchronization is determined by the maximum correlated value. After slot and frame synchronization are achieved, the mobile UE device may perform any other required operations to complete the network connection.

To achieve time synchronization between the mobile UE and a base station when establishing connections during power up operations, for example, the mobile UE may need to lock in to a reference frequency provided by the base station. In most instances, the mobile UE utilizes a local voltage controlled oscillator, such as a crystal oscillator, that is used to generate a carrier frequency for the RF and analog portions of the device and to generate a reference digital clock for the digital portion of the device. When a high quality crystal oscillator is utilized, the frequency uncertainty or frequency offset of the crystal oscillator may be very small, and with proper calibration operations, the crystal oscillator may be enabled to generate the appropriate carrier frequency and/or digital clock signals for time-synchronization during power up operations, for example. However, the cost of the high quality crystal oscillator and the expense associated with the calibration operations may be prohibitively high. In this regard, lower quality crystal oscillators that possess larger frequency uncertainty may be necessary in order to meet cost requirements. However, the use of lower quality crystal oscillators requires the implementation of cost effective mechanisms to guarantee that the frequency offset of the lower quality crystal oscillator does not result in instances where the mobile UE performs the synchronization operations—that are necessary to establish and/or maintain connections with the base station—by using excessive time with the result of a low quality product.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

An apparatus and/or method is provided for a user equipment (UE) channel acquisition in the presence of large frequency uncertainty in wideband code division multiple access (WCDMA) signals, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram illustrating frequency control in a WCDMA mobile device for power up operations, in accordance with an embodiment of the invention.

FIG. 2A is block diagram illustrating a portion of a primary synchronization channel (P-SCH) data path in a WCDMA device, in accordance with an embodiment of the invention.

FIG. 2B is a block diagram illustrating a remaining portion of the P-SCH data path in a WCDMA device, in connection with an embodiment of the invention.

FIG. 2C is a flow diagram illustrating exemplary steps in the processing of P-SCH data, in accordance with an embodiment of the invention.

FIG. 3 is a block diagram illustrating an exemplary circuit interface for a VCTXO, in accordance with an embodiment of the invention.

FIG. 4 is a diagram illustrating the testing of the frequency offset in the crystal oscillator by the PSYNC block, in accordance with an embodiment of the invention.

FIG. 5 is a flow diagram illustrating exemplary steps for testing the frequency offset of the crystal oscillator, in accordance with an embodiment of the invention.

FIG. 6 is a diagram illustrating exemplary plots of the peak-to-noise-floor-average ratio versus frequency offset for several lor/loc values, in accordance with an embodiment of the invention.

### DETAILED DESCRIPTION OF THE INVENTION

Certain embodiments of the invention may be found in a method and apparatus for a user equipment (UE) channel acquisition in the presence of large frequency uncertainty in wideband code division multiple access (WCDMA) signals. Certain scenarios may exist in mobile cell communication where a mobile device may not have prior information on the correct setting that enables the mobile device to generate an RF frequency, within a strict tolerance, that in return facilitates the full time-frequency synchronization with a base station. Such scenario may occur, for example, when turning ON the mobile device, also known as cold start. In this instance, the mobile device may generate an RF frequency based on a factory setting that in return may rely on the mobile device's oscillator stability during the oscillator's lifetime and temperature. In most instances, after turning the mobile device ON, the mobile device may generate, after a settling time, the required RF frequency. Having the required RF frequency may facilitate a time search for establishing the complete time-frequency synchronization between the mobile device and a base station. Relaxing the stability requirements of the oscillator may turn a one dimensional synchronization search, such as a search based on time, into a two-dimensional search, based on time and frequency. In this regard, the frequency uncertainty may be partitioned into a grid of frequencies. At each of the frequencies, a time search may be carried out to achieve time synchronization. Such an approach may increase the acquisition time of the WCDMA channel several folds.

Aspects of the method and apparatus for a UE channel acquisition in the presence of large frequency uncertainty in WCDMA signals may result in performing efficient time-frequency search and may be utilized to quantify, that is, estimate, an unknown frequency tolerance, for example. This approach may therefore facilitate an optimal partitioning of an unknown frequency range into a search grid. Such an approach may enable the usage of RF oscillators, in WCDMA applications, for example, that may have larger tolerance and therefore lower cost. The approach described herein need not be limited to WCDMA applications, and may be generally utilized in communication systems where such problem exists.

A WCDMA mobile device or user equipment (UE) may comprise a baseband (BB) processor that is enabled to detect a primary synchronization channel (P-SCH) code for initial network synchronization. In instances where the mobile device utilizes the correct RF frequency, the initial synchronization may correspond to a search for the time location of the P-SCH code. In this process, the UE may test a time grid, for example, of 5120 locations. In the case the frequency is unknown, a two dimensional grid of frequency and time may be created. In this instance, the mobile device may require a search of 5120 locations for each frequency point, for example.

Criteria may be configured that may assign a single measure of reliability to each group of 5120 points, for example, allowing the rejection of frequency points with low likelihood. In this regard, the criteria utilized may correspond and/or be based on the peak signal power to mean noise power ratio, for example. A portion of the BB processor may generate a plurality of signal peak-to-noise-floor-average ratios associated with a plurality of test frequencies produced by a local oscillator, such as a crystal oscillator, for example, in the WCDMA UE. A highest of the signal peak-to-noise-floor-average ratios may be selected to determine the frequency offset of the crystal oscillator for use in power up operations. A plurality of digital control signals may be generated to test the frequency offset of the crystal oscillator. The crystal oscillator may be one of a voltage controlled crystal oscillator (VCXO), a temperature compensated crystal oscillator (TCXO), and a voltage controlled temperature compensated crystal oscillator (VCTCXO).

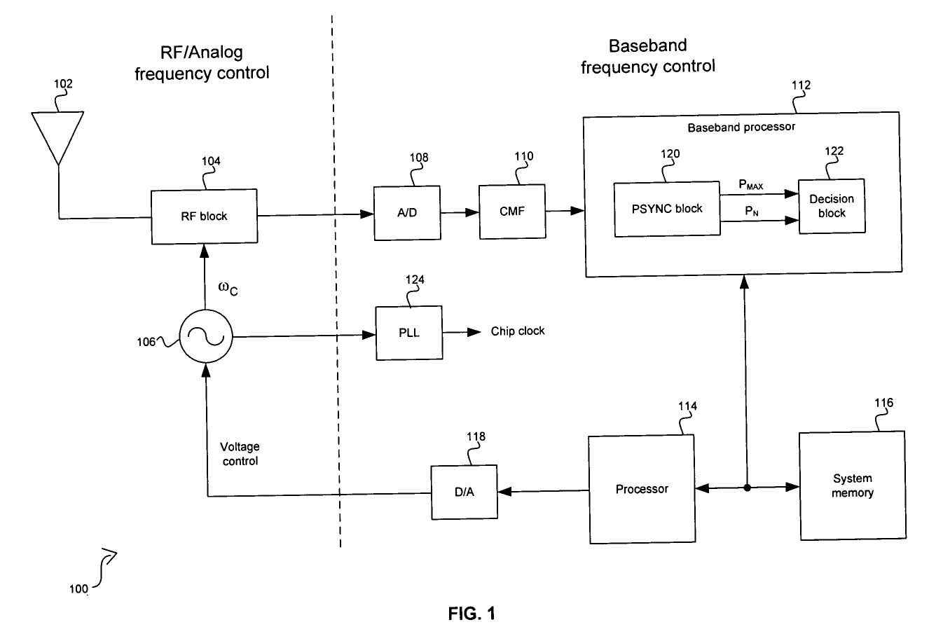

FIG. 1 is a block diagram illustrating frequency control in a WCDMA mobile device for power up operations, in accordance with an embodiment of the invention. Referring to FIG. 1, there is shown a WCDMA mobile device 100 that may comprise an RF/analog portion that comprises an antenna 102, an RF block 104, and a signal generator 106. The WCDMA mobile device 100 may also comprise a baseband (BB) portion comprises an analog-to-digital (A/D) converter 108, a chip matched filter (CMF) 110, a BB processor 112, a processor 114, a system memory 116, a digital-to-analog (D/A) converter 118, and a phase-locked loop (PLL) 124. The BB processor 112 may comprise a primary synchronization (PSYNC) block 120 and a decision block 122.

The antenna 102 may comprise suitable logic and/or circuitry that may enable communicating with at least one base station. Communication with a base station may comprise receiving data via a physical synchronization channel (SCH) specified by the WCDMA requirements. In this regard, the WCDMA mobile device 100 may receive primary synchronization codes (PSCs) via a primary synchronization channel (P-SCH) and secondary synchronization codes (SSCs) via a secondary synchronization channel (S-SCH), for example. Synchronization codes are transmitted by the network to indicate slot and frame timing to the WCDMA mobile device 100. The P-SCH channel may be used for initial network synchronization with a WCDMA compliant UE, such as the WCDMA mobile device 100, for example.

The RF block 104 may comprise suitable logic, circuitry, and/or code that may enable conversion of the RF modulated signals received by the antenna 102 into baseband signals that may be transferred to the baseband processor 112 for further processing. The RF block 104 may utilize a carrier frequency, ω_{C}, generated by the signal generator 106 to demodulate the received RF signals. The signal generator 106 may comprise suitable logic, circuitry, and/or code that may enable generation of a carrier frequency that enables the RF block 104 to demodulate received RF signals. The value of the carrier frequency, ω_{C}, needs to be within an uncertainty level or frequency offset in order for the demodulation operation of the RF block 104 to be effective. The signal generator 106 may comprise a crystal oscillator (XO), for example, to generate the carrier frequency. In many instances, the XO in the signal generator 106 may need to be controllable in order to generate a plurality of carrier frequencies. In this regard, the XO in the signal generator 106 may be a voltage controlled crystal oscillator (VCXO), a temperature compensated crystal oscillator (TCXO), or a voltage controlled temperature compensated crystal oscillator (VCTCXO), for example.

The A/D converter 108 may comprise suitable logic, circuitry, and/or code that may enable digitization of the baseband analog signals generated by the RF block 104. The output of the A/D converter 108 may be communicated to the CMF 110 that may comprise suitable logic, circuitry, and/or code that may enable match filtering of the digitized baseband signals. The baseband processor 112 may comprise suitable logic, circuitry, and/or code that may enable further processing of the digitized baseband signals.

The PSYNC block 120 may comprise suitable logic, circuitry, and/or code that may enable processing of primary synchronization codes from the primary synchronization channel in order to synchronize the WCDMA mobile device 100 with a base station in the cellular network, for example. The PSYNC block 120 may generate the result values of searching 5120 time locations of a certain frequency grid point. The PSYNC block 120 may enable generating a signal peak value, P_{MAX}, and a floor-noise-average value, P_{N}, for a primary synchronization code received while dwelling on a given frequency, for example. This process may be repeated for various carrier frequencies. The signal peak value, P_{MAX}, and a floor-noise-average value, P_{N}, may be utilized by the baseband processor 112 to detect the primary synchronization codes and establish initial synchronization with the cellular network. The PSYNC block 120 may be utilized by the WCDMA mobile device 100 for detecting frequencies during frequency searching operations, for example. Moreover, the PSYNC block 120 may be utilized to test and determine the offset frequency of the crystal oscillator in the signal generator 106 described in FIG. 1, for example. The decision block 122 may comprise suitable logic, circuitry, and/or code that may enable generating a signal ratio or signal peak-to-noise-floor-average ratio of the signal peak value, P_{MAX}, and the floor-noise-average value, P_{N}, for each carrier frequency.

The processor 114 may comprise suitable logic, circuitry, and/or code that may enable controlling the operations of the baseband processor 112, for example. The processor 114 may also be utilized to test the frequency offset of the crystal oscillator in the signal generator 106. For example, the processor 114 may generate a plurality of digital control signals that may be communicated to the D/A converter 118. Each of the digital control signals may correspond to a different carrier frequency to be generated by the signal generator 106. For each carrier frequency generated from the digital control signals, the PSYNC block 120 may generate a signal peak value, P_{MAX}, and a floor-noise-average value, P_{N}, and the decision block 122 may generate signal peak-to-noise-floor-average ratio. The processor 114 may utilize the resulting signal peak-to-noise-floor-average ratios to determine the frequency offset of the crystal oscillator in the signal generator 106. The D/A converter 118 may comprise suitable logic, circuitry, and/or code for converting the digital control signals generated by the processor 118 to analog control signals that may be utilized to control the operation of the signal generator 106.

The system memory 116 may comprise suitable logic, circuitry, and/or code that may enable storing data, including signal peak values, floor-noise-average values, and/or signal peak-to-noise-floor-average ratios that may be utilized by the WCDMA mobile device 100 to establish and/or maintain network connections with the network. Moreover, the values stored in the system memory 116 may also be utilized to determine the frequency offset of the crystal oscillator in the signal generator 106. The PLL 124 may comprise suitable logic, circuitry, and/or code that may enable generation of a chip or system digital clock based on the carrier frequency generated by the signal generator 106. In this regard, when the carrier frequency, ω_{C}, is synchronized to the reference signal received by the WCDMA mobile device 100 from the network, the digital clock signal utilized by, for example, the baseband processor 112 is also synchronized to the reference signal received from the network.

In operation, RF signals from the network are received by the antenna 102 and are communicated to the RF block 104. The RF block 104 may demodulate the received RF signals based on the carrier frequency, ω_{C}, generated by the signal generator 106. When the crystal oscillator in the signal generator 106 is of higher quality, the frequency offset of the crystal oscillator is small and the carrier frequency generated may be appropriate for demodulation of the received RF signals. Higher-quality in this regard may refer to long-term stability and low temperature drift as defined by the system requirement, for example. When the crystal oscillator in the signal generator 106 is of lower quality, the carrier frequency uncertainty, that is, the frequency offset, may be large and the RF block 104 may be unable to effectively demodulate the received RF signals. Similarly, the uncertainty or offset in the carrier frequency may also affect baseband operations by producing a digital clock signal in the PLL 124 that is not accurately synchronized to the network reference signals.

The demodulated RF signals may be digitized by the A/D converter 108 and filtered by the CMF 110 before being communicated to the baseband processor 112. The PSYNC block 120 may process the primary synchronization codes in order to enable the WCDMA mobile device 100 to perform the initial synchronization with the network. The results from the PSYNC block 120 may also be utilized by the decision block 122 to generate signal peak-to-noise-floor-average ratios from which the processor 114 may determine the frequency offset in the crystal oscillator.

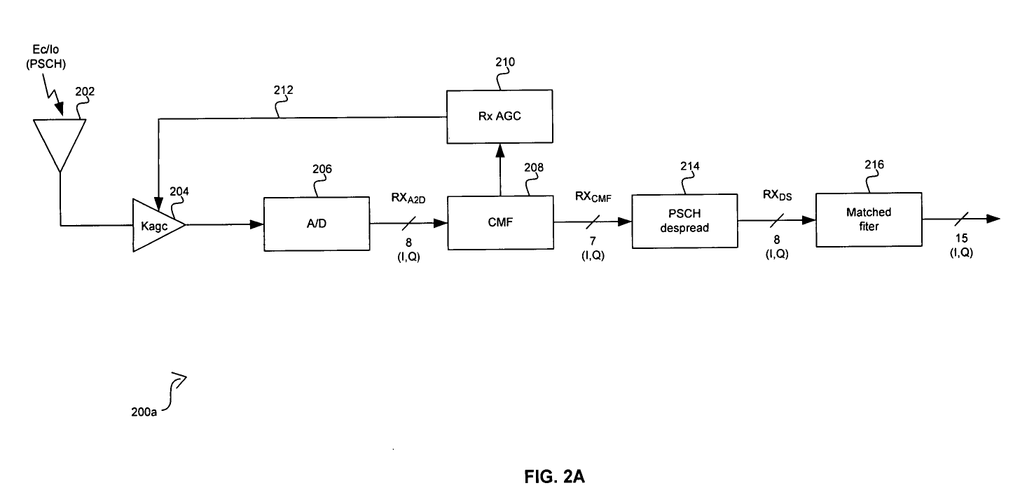

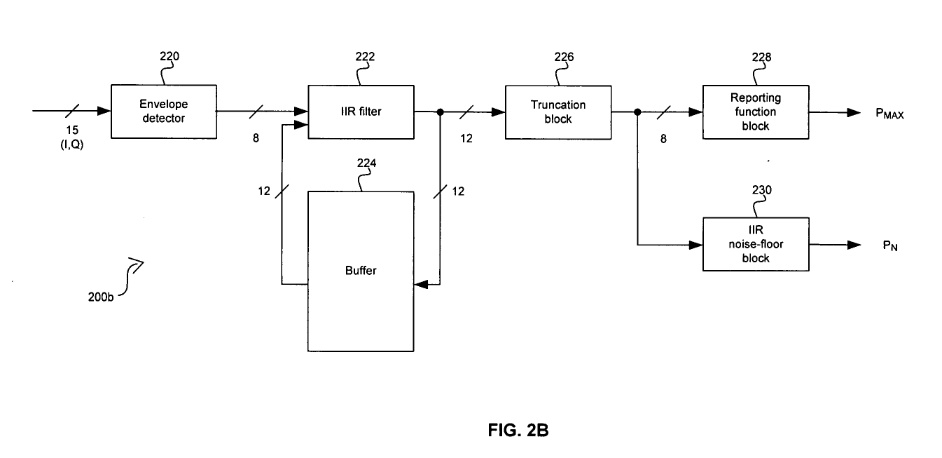

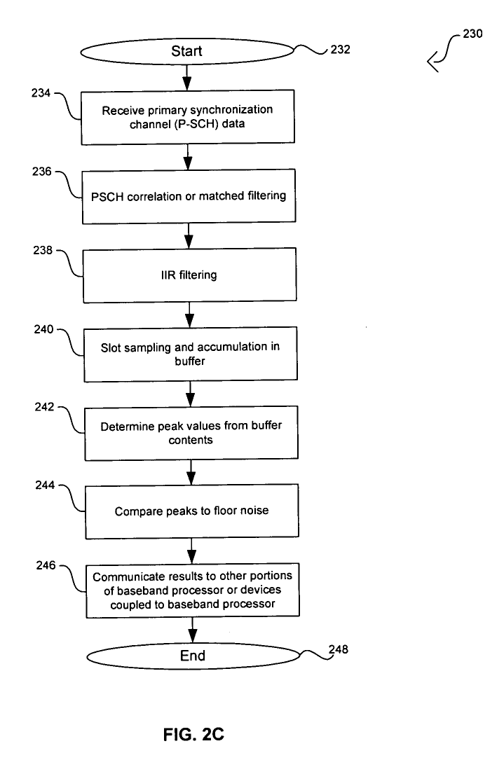

FIG. 2A is block diagram illustrating a portion of a primary synchronization channel (P-SCH) data path in a WCDMA device, in accordance with an embodiment of the invention. Referring to FIG. 2A, there is shown a data path 200a corresponding to a portion of a WCDMA mobile device that processes data received via the primary synchronization channel (P-SCH). In this regard, the data path 200a may correspond to a portion of the WCDMA mobile device 100 described in FIG. 1, for example. Moreover, a portion of the data path 200a may correspond to the PSYNC block 120 in FIG. 1, for example. The data path 200a may comprise an antenna 202, an amplifier 204, an analog-to-digital (A/D) converter 206, a chip matching filter (CMF/) 208, a receiver (Rx) automatic gain controller (AGC) 210, a primary synchronization channel (P-SCH) despreader 214, and a matched filter 216.

The antenna 202 may comprise suitable logic and/or circuitry that may enable receiving P-SCH data and may facilitate measurements of the primary sync power density, Ec, the interference power density level at the antenna, loc, the power density at the antenna of a received path, lor, and/or the total RF power or total received power spectral density, lo, where lo=loc+lor. The amplifier 204 may comprise suitable logic, circuitry, and/or code that may be utilized to increase or decrease the received signal strength based on a feedback signal 212 provided by the Rx AGC 210. The A/D converter 206 may comprise suitable logic, circuitry, and/or code that may enable digitization of the output of the amplifier 204 to generate the signal RX_{A2D}. The signal RX_{A2D} may comprise 8-bit in-phase (I) and quadrature (Q) signals, for example.

The CMF 208 may comprise suitable logic, circuitry, and/or code that may enable match filtering of the output signals generated by the A/D converter 206. The CMF 208 may be utilized to generate at least one signal that may be utilized by the Rx AGC 210 to generate the feedback signal 212 to the amplifier 204. The CMF 208 may generate a signal RX_{CMF} that may comprise 7-bit I/Q signals, for example. The P-SCH despreader 214 may comprise suitable logic, circuitry, and/or code that may enable dispreading of the RX_{CMF} signal to generate the RX_{DS} signal as input to the matched filter 216. The RX_{DS} signal may comprise 8-bit I/Q signals, for example. The matched filter 216 may comprise suitable logic, circuitry, and/or code that may enable match filtering or correlation of the RX_{DS} signal to generate a correlated signal that may comprise 15-bit I/Q signals, for example. The P-SCH code may be repeated by the base station at every slot, for example. A slot period, according to the WCDMA standard, may consist of 2560 chips, where the duration of a chip is 1/3.84e6 sec. In this regard, 5120 correlation values, that is, twice per chip time, may be generated. Each of the generated correlation values may be associated with the hypothesis that the slot boundaries are located at that point. As a result, the 5120 correlation values may represent 5120 hypotheses for the boundaries of a slot to be located anywhere within time period of 2560-chips.

FIG. 2B is a block diagram illustrating a remaining portion of the P-SCH data path in a WCDMA device, in connection with an embodiment of the invention. The portion of the WCDMA mobile device described in a data path 200b may follow the portion of the WCDMA mobile device described by the data path 200a. In this regard, the data path 200b may correspond to a portion of the WCDMA mobile device 100 described in FIG. 1, for example. Moreover, a portion of the data path 200b may correspond to the PSYNC block 120 in FIG. 1, for example. The data path 200b may comprise an envelope detector 220, an infinite impulse response (IIR) filter 222, a buffer 224, a truncation block 226, a reporting function block 228, and an IIR noise-floor block 230.

The system described by the data path 200b may enable measuring the noise power and the peak power of the entire 5120 hypotheses and combine or filter the current measurement of, for example, hypothesis n with a measurement n+5120, where n may correspond to a counter value associated with each measurement. The envelope detector 220 may comprise suitable logic, circuitry, and/or code that may enable generating a signal by detecting the measured envelope of the in-phase and quadrature signals generated by the matched filter 216 in FIG. 2A at twice per a chip time. The output of the envelope detector 220 may be an 8-bit signal, for example, that may be communicated to the IIR filter 222. The IIR filter 222 may comprise suitable logic, circuitry, and/or code that may enable digital filtering of the signal received from the envelope detector 220. In this regard, the n^{th} magnitude or envelop of the correlation output that is input to the IIR filter 222 may be filtered with the magnitude (n−5120)^{th} that is stored in the buffer 224. The new filter output may then be stored in buffer 224, therefore maintaining the updated outcome for each of the 5120 hypotheses. The filtering process may be cast as a filtering of 5120 signals. Results from the IIR filter 222 may be transferred to the truncation block 226 and/or to the buffer 224 in 12-bit words, for example. The buffer 224 may comprise suitable logic, circuitry, and/or code that may enable storage of filtered data and to feed back stored filtered data to the IIR filter 222. The buffer 224 may be implemented using a random access memory (RAM).

The truncation block 226 may comprise suitable logic, circuitry, and/or code that may enable truncating the digital output of the IIR filter 222 into a predetermined number of bits. For example, the truncation block 226 may truncate 12-bit words into 8-bit words for processing by the reporting function block 228 and the IIR noise-floor block 230. The reporting function block 228 may comprise suitable logic, circuitry, and/or code that may enable generating signal peak values, P_{MAX}, for primary synchronization codes that have been determined by operations performed by the data paths 200a and 200b for various frequencies. The IIR noise-floor block 230 may comprise suitable logic, circuitry, and/or code that may enable generating floor-noise-average values, P_{N}, for primary synchronization codes that have been determined by operations performed by the data paths 200a and 200b for various frequencies. The signal peak values, P_{MAX}, and the floor-noise-average values, P_{N}, may be utilized by the baseband processor 112 in the WCDMA mobile device 100 to perform frequency searches, for example.

Moreover, the signal peak values, P_{MAX}, and the floor-noise-average values, P_{N}, may be utilized by the decision block 122 in the baseband processor 112 to generate signal peak-to-noise-floor-average ratios, R=P_{MAX}/P_{N}, that may be utilized by the processor 114 to determine the frequency offset of the crystal oscillator in the signal generator 106. For example, the processor 114 may generate a plurality of control signals to vary the frequency of the crystal oscillator and therefore the carrier frequency applied to the RF block 104 in FIG. 1. A signal peak-to-noise-floor-average ratio may be determined for each of the carrier frequencies generated. The decision block 122 may determine a highest of the signal peak-to-noise-floor-average ratios that may be communicated to the processor 114. The processor 114 may associate an offset frequency and a corresponding digital control signal to the highest signal peak-to-noise-floor-average ratio. The corresponding digital control signal may then be utilized to generate the appropriate carrier frequency that may be utilized for synchronization with the network during power up operations.

In an exemplary embodiment of the invention in which the WCDMA mobile device 100 is performing single frequency searches by using the P-SCH data paths 200a and 200b, for example, an entire slot may be sampled and accumulated into the buffer 224 which may have a capacity to store 5120 12-bit samples. The WCDMA mobile device 100 may enable performing searches at two times the chip rate. When a single sample per chip is utilized instead, the buffer 224 may be split into two portions, each comprising sufficient capacity to store 2560 samples or one half the number of frequencies of interest. The contents of the buffer 224 may be filtered to select the 16 or 32 greatest peaks, for example, that are contained in the buffer 224 and these positions may be passed to a searcher software for further processing. In order to further enhance the quality of the peaks may be compared to the output of the IIR filter noise floor block 230 and any peak exceeding the noise floor by a certain margin may be handed to the rest of the searcher for processing. This avoids unnecessary processing of paths that may are likely to be false.

FIG. 2C is a flow diagram illustrating exemplary steps in the processing of P-SCH data, in accordance with an embodiment of the invention. Referring to FIG. 2C, there is shown a flow diagram 230 comprising a start step 232. In step 234, the P-SCH data path 200a receives P-SCH data via the antenna 202. In step 236, after performing gain, digitization, chip match filtering, and dispreading, the data path 202a may perform P-SCH correlation or match filtering in the matched filter 216. The in-phase and quadrature signal outputs of the matched filter 216 may be communicated to the envelope detector 220 in the P-SCH data path 200b. The output of the envelope detector 220 may be communicated to the IIR filter 222. In step 238, the IIR filter 222 may filter the output of the envelope detector 220. In step 240, the results of the IIR filter 222 may be stored in the buffer 224 and the stored results may be fed back to the IIR filter 222 for slot sampling and accumulation. In step 242, peak values may be selected from the contents of the buffer 224 for frequency searching operations. In step 244, peak values and floor-noise values generated by the reporting function block 228 and the IIR noise-floor block 230 respectively, may be compared for either frequency searching operations or for determining the offset frequency of the crystal oscillator. In step 246, the results of the comparison performed in step 244 may be communicated to other portions of the baseband processor 112 or to other devices communicatively coupled to the baseband processor 112.

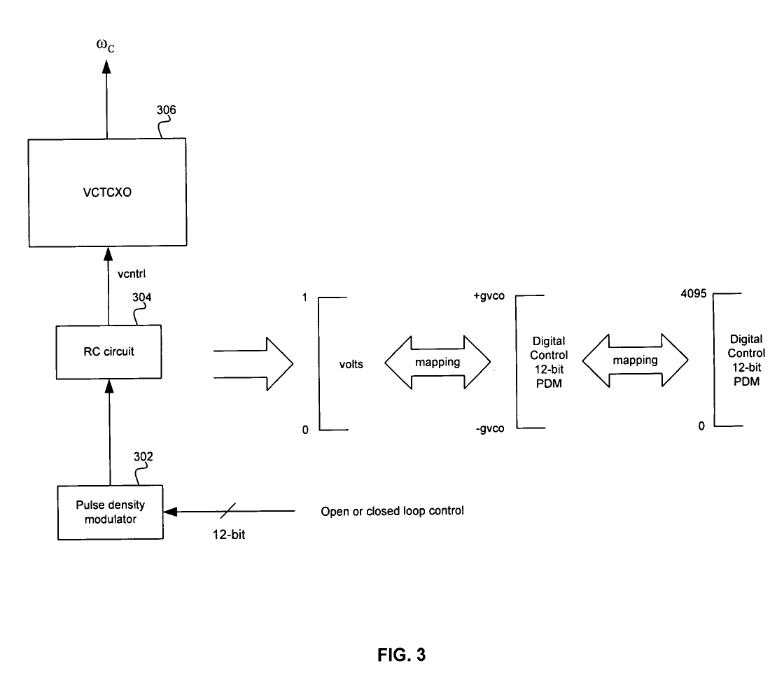

FIG. 3 is a block diagram illustrating an exemplary circuit interface for a VCTXO, in accordance with an embodiment of the invention. Referring to FIG. 3, there is shown a voltage controlled temperature compensated crystal oscillator (VCTCXO) 306, a resistor-capacitor (RC) filter 304, and a digital to analog converter, generally known as a pulse density modulator (PDM) 302. Other types of crystal oscillators, such as TCXO and VCXO, for example, may also be considered. In this example, the VCTCXO 306 may have a central control range, PPM_{CENTRAL}_{_{—}}_{RANGE}, of 15 parts-per-million (PPM), for a total dynamic control range of 30 PPM. The VCTCXO 306 may correspond to a voltage-controlled device that operates with input voltages, vcntrl, ranging from 0 to 1 volts. The voltage range may map to a device gain range of −gvco to +gvco, where gvco=PPM_{CENTRAL}_{_{—}}_{RANGE}·2e3, assuming a carrier frequency of 2 GHz. When a 12-bit digital control word or signal is generated by the processor 114 to control the operation of the VCTCXO 306, a range of 0 to 4095 digital words may be mapped to the voltage range and the gain range of the device. In most instances, not all 4096 digital control words may be utilized. For example, when a 2 PPM accuracy is required for testing the frequency offset of the VCTCXO 306, 15 digital control words may be sufficient to cover the total dynamic control range of 30 PPM. The frequency accuracy, δf, of each 12-bit digital control word applied to the VCTCXO 306 may given by the expression:

$$δ f = \frac{2 \times {PPM}_{CENTRAL\_RANGE} \times 2 e 3}{4096} ≅ 14.65 Hz . \qquad ( 1 )$$

The offset frequency, Δf, produced by the VCTCXO 306 may be determined from the expression:
Δf=f_{—}err−gvco×[2×vcntrl−1]. (2)
where f_err corresponds to the frequency error determined when selecting the highest of the signal peak-to-noise-floor-average ratio generated by the PSYNC block 120 and the decision block 122, and gvco and vcntrl are determined from the characteristics of the device and the digital control word applied respectively.

In operation, the processor 114 may be utilized to test the frequency offset of the VCTCXO 306 by monitoring the signal peak-to-noise-floor-average ratio generated by the PSYNC block 120 and the decision block 122 in the baseband processor 112 while generating a plurality of digital control signals that are utilized to control the carrier frequency produced by the VCTCXO 306. The number of digital control words may depend on the accuracy being used. The processor 114 may generate a plurality of digital control signals, for example 15 for a 2 PPM accuracy when the total dynamic control range is 30 PPM. The PDM 302 and the RC filter 304 convert the digital control words into analog voltages, vcntrl. For example, a 12-bit digital control signal may be utilized by the PDM 302 to generate a pulse with a pulse width specified by the digital value. The pulse may be integrated by the RC filter 304 to generate an analog control voltage, vcntrl, with a magnitude proportional to the digital value of the digital control signal. The analog control voltage, vcntrl, may then be applied to the VCTCXO 306 to generate a carrier frequency, ω_{C}. The processor 114 monitors the results of the signal peak-to-noise-floor-average ratio, R, generated by the PSYNC block 120 and the decision block 122 to determine whether the currently applied digital control signal results in a highest signal peak-to-noise-floor-average ratio. When a highest value of R is determined, the offset frequency, Δf, may be determined from the frequency error, f_err, as described in equation (2).

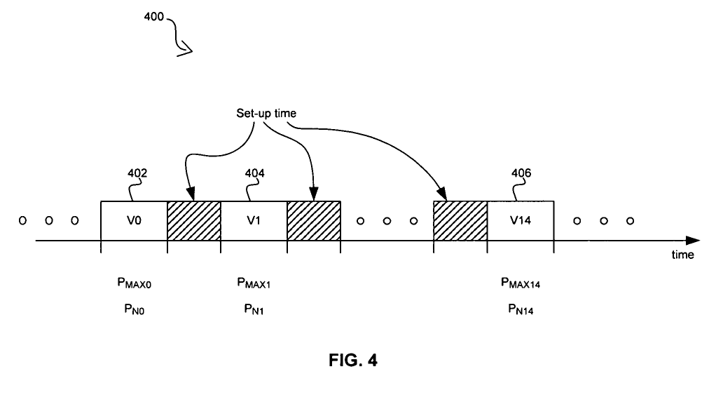

FIG. 4 is a diagram illustrating the testing of the frequency offset in the crystal oscillator by the PSYNC block, in accordance with an embodiment of the invention. Referring to FIG. 4, there is shown a time plot 400 that illustrates the application of analog control voltages, vcntrl, to the VCTCXO 306 in FIG. 3. For example, when 15 digital control words are generated by the processor 114 to test the frequency offset of the VCTCXO 306, the PDM 302 and the RC filter 304 may convert those signals into 15 analog control voltages V₀, . . . , V₁₄. FIG. 3 shows V₀ labeled as 402, V₁ labeled as 404, and V₁₄ labeled as 406. The analog control voltages are applied sequentially and a set-up time is provided before the application of a next analog control voltages. Thus at each period 402, 404 and 406 the VCTXO is set to a different frequency by controlling its voltage input V₀, . . . , V₁₄.

For each analog control voltage V₀, . . . , V₁₄, the PSYNC block 120 generates a corresponding signal peak value, P_{MAX}, and a floor-noise-average value, P_{N}, that may be utilized to determine a signal peak-to-noise-floor-average ratio, R, for each of the 15 analog control voltages V₀, . . . , V₁₄ applied to the VCTCXO 306. For example, when V₀ is applied the PSYNC block 120 generates the values P_{MAX0} and P_{N0}, P_{MAX1} and P_{N1} when V₁ is applied, and P_{MAX14} and P_{N14} when V₁₄ is applied. In this regard, the decision block 122 may generate the signal peak-to-noise-floor-average ratios R₀=P_{MAX0}/P_{N0}, R₁=P_{MAX1}/P_{N1}, . . . , and R₁₄=P_{MAX14}/P_{N14}. The highest of the 15 signal peak-to-noise-floor-average ratios may be selected to determine the frequency offset of the VCTCXO 306.

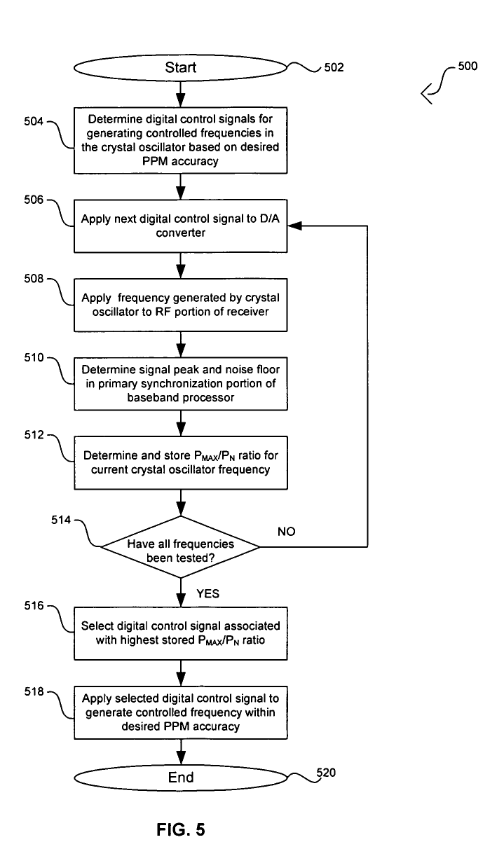

FIG. 5 is a flow diagram illustrating exemplary steps for testing the frequency offset of the crystal oscillator, in accordance with an embodiment of the invention. Referring to FIG. 5, there is shown a flow diagram 500. In step 504, after start step 502, the digital control signals or words that may be used to test the frequency offset of the crystal oscillator in the signal generator 106 in FIG. 1 may be determined based on the accuracy desired. For example, for a device with a total dynamic control range of 30 PPM, a 2 PPM accuracy may require 15 digital control signals or words for testing the frequency offset. In step 506, the first digital control signal may be applied by the processor 114 to the D/A converter 118 to generate a voltage control signal to control the carrier frequency, ω_{C}, produced by the crystal oscillator. In step 508, the carrier frequency may be applied to the RF block 104 of the WCDMA mobile device 100 to perform demodulation operations. In step 510, the PSYNC block 120 in the BB processor 112 may generate a signal peak value, P_{MAX}, and a floor-noise-average value, P_{N}, for the current digital control word being utilized. In step 512, the decision block 122 may determine a signal peak-to-noise-floor-average ratio, R, for the current values of P_{MAX} and P_{N}.

In step 514, when additional digital control signals corresponding to additional carrier frequencies remain to be tested, the process may proceed to step 506 where the next digital control signal may be applied by the processor 114 to the D/A converter 118 to generate a next voltage control signal to control the carrier frequency, ω_{C}, produced by the crystal oscillator. Returning to step 514, when all additional digital control signals corresponding to additional carrier frequencies have been tested, the process may proceed to step 516. In step 516, the decision block 122 or the processor 114 may select the highest of the signal peak-to-noise-floor-average ratios determined for all the tested digital control signals, thus selecting the most likely frequency offset. Furthermore, the ratio measured is directly related to the frequency error, that is, the frequency offset. As a result, the highest of the signal peak-to-noise-floor-average ratios may be utilized to determine the frequency offset of the crystal oscillator. In step 518, the processor 114 may apply a digital control signal that compensates for the frequency offset and results in a carrier frequency within the desired level of accuracy. After step 518, the process may proceed to end step 520.

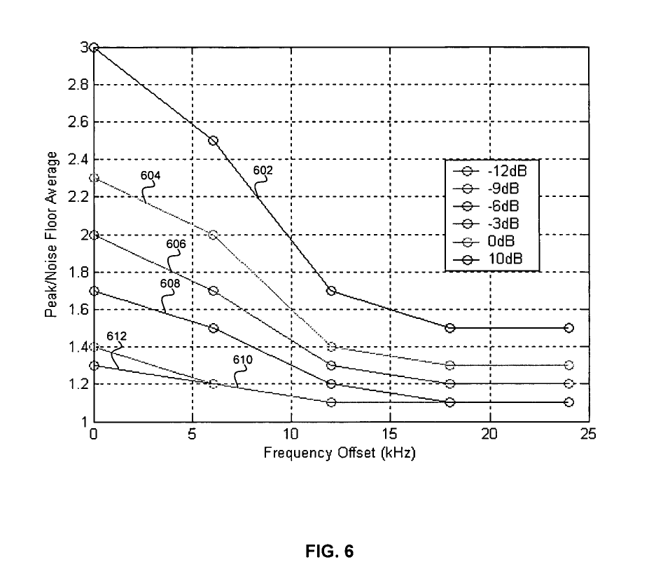

FIG. 6 is a diagram illustrating exemplary plots of the peak-to-noise-floor-average ratio versus frequency offset for several lor/loc values, in accordance with an embodiment of the invention. Referring to FIG. 6, there is shown a first plot 602, a second plot 604, a third plot 606, a fourth plot 608, a fifth plot 610 and a sixth plot 612, wherein each plot corresponds to a signal peak-to-noise-floor-average ratio plot for a different value of lor/loc. For example, the first plot 602 corresponds to lor/loc=10 dB, the second plot 604 corresponds to lor/loc=0 dB, the third plot 606 corresponds to lor/loc=−3 dB, the fourth plot 608 corresponds to lor/loc=−6 dB, the fifth plot 610 corresponds to lor/loc=−9 dB, and the sixth plot 612 corresponds to lor/loc=−12 dB.

The WCDMA mobile device 100 may determine the frequency offset of a crystal oscillator for a certain carrier frequency based on signal peak-to-noise-floor-average results such as those shown in FIG. 6. For example, for lor/loc=10 dB, a highest signal peak-to-noise-floor-average ratio measurement of 2.5 indicates a ˜6 KHz offset. In this regard, the processor 114 may select a digital control signal that may compensate for the 6 KHz offset and produce the desired carrier frequency for performing synchronization during power up operations. Similarly, for lor/loc=−3 dB, a highest signal peak-to-noise-floor-average ratio measurement of 1.7 also indicates a ˜6 KHz offset, prompting the processor 114 to select the appropriate digital control signal to produce the appropriate carrier frequency.

The approach described herein may result in a cost effective mechanism that enables the use of lower quality crystal oscillator in WCDMA mobile user equipments for supporting synchronization operations that are necessary to establish and/or maintain connections with the network.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for signal processing in a wireless device, the method comprising:
detecting using circuitry within a baseband processor, a known transmitted pattern signal for a communication system; and
determining using results produced by said circuitry within said baseband processor, frequency offsets of signals produced by a local oscillator that is utilized for demodulating said known transmitted pattern signal.

2. The method according to claim 1, further comprising correlating said known transmitted pattern signal for said detecting.

3. The method according to claim 1, wherein said known transmitted pattern signal is a primary synchronization channel (PSC) code for wideband code division multiple access (WCDMA).

4. The method according to claim 1, further comprising measuring a signal peak for a plurality of signals over a specified time period and over range of signal frequencies produced by said local oscillator.

5. The method according to claim 4, further comprising measuring a noise-floor-average based on a plurality of envelops measured for each of said plurality of signal frequencies produced by said local oscillator.

6. The method according to claim 5, further comprising generating a signal peak-to-noise-floor-average ratio for each of said plurality of signal frequencies produced by said local oscillator based on a corresponding detected signal peak and a corresponding detected noise-floor-average.

7. The method according to claim 1, further comprising generating a plurality of digital control signals to produce a plurality of signal frequencies by said local oscillator.

8. The method according to claim 1, wherein said local oscillator is one of a voltage controlled crystal oscillator (VCXO), a temperature compensated crystal oscillator (TCXO), and a voltage controlled temperature compensated crystal oscillator (VCTCXO).

9. A machine-readable storage having stored thereon, a computer program having at least one code section for signal processing in a wireless device, the at least one code section being executable by a machine for causing the machine to perform steps comprising:
detecting using circuitry within a baseband processor, a known transmitted pattern signal for a communication system; and
determining using results produced by said circuitry within said baseband processor, frequency offsets of signals produced by a local oscillator that is utilized for demodulating said known transmitted pattern signal.

10. The machine-readable storage according to claim 9, further comprising code for correlating said known transmitted pattern signal for said detecting.

11. The machine-readable storage according to claim 9, wherein said known transmitted pattern signal is a primary synchronization channel (PSC) code for wideband code division multiple access (WCDMA).

12. The machine-readable storage according to claim 9, further comprising code for measuring a signal peak for a plurality of signals over a specified time period and over range of signal frequencies produced by said local oscillator.

13. The machine-readable storage according to claim 12, further comprising code for measuring a noise-floor-average based on a plurality of envelops measured for each of said plurality of signal frequencies produced by said local oscillator.

14. The machine-readable storage according to claim 13, further comprising code for generating a signal peak-to-noise-floor-average ratio for each of said plurality of signal frequencies produced by said local oscillator based on a corresponding detected signal peak and a corresponding detected noise-floor-average.

15. The machine-readable storage according to claim 9, further comprising code for generating a plurality of digital control signals to produce a plurality of signal frequencies by said local oscillator.

16. The machine-readable storage according to claim 9, wherein said local oscillator is one of a voltage controlled crystal oscillator (VCXO), a temperature compensated crystal oscillator (TCXO), and a voltage controlled temperature compensated crystal oscillator (VCTCXO).

17. A system for processing signals in a wireless device, the system comprising:
a baseband processor, a processor, and a local oscillator;
said baseband processor comprises circuitry that enables detection of a known transmitted pattern signal for a communication system; and
said processor enables determination of, using results produced by said circuitry within said baseband processor, frequency offsets of signals produced by said local oscillator that is utilized for demodulating said known transmitted pattern signal.

18. The system according to claim 17, wherein said baseband processor enables correlating said known transmitted pattern signal for said detecting.

19. The system according to claim 17, wherein said known transmitted pattern signal is a primary synchronization channel (PSC) code for wideband code division multiple access (WCDMA).

20. The system according to claim 17, wherein said baseband processor enables measuring a signal peak for a plurality of signals over a specified time period and over range of signal frequencies produced by said local oscillator.

21. The system according to claim 20, wherein said baseband processor enables measuring a noise-floor-average based on a plurality of envelops measured for each of said plurality of signal frequencies produced by said local oscillator.

22. The system according to claim 21, wherein said baseband processor enables generating a signal peak-to-noise-floor-average ratio for each of said plurality of signal frequencies produced by said local oscillator based on a corresponding detected signal peak and a corresponding detected noise-floor-average.

23. The system according to claim 17, wherein said processor enables generating a plurality of digital control signals to produce a plurality of signal frequencies by said local oscillator.

24. The system according to claim 17, wherein said local oscillator is one of a voltage controlled crystal oscillator (VCXO), a temperature compensated crystal oscillator (TCXO), and a voltage controlled temperature compensated crystal oscillator (VCTCXO).
